(19) United States
(12) Patent Application Publication
(10) Pub. No.: US 2007/0213465 A1
(43) Pub. Date: Sep. 13, 2007

(54) Moisture-Hardening Hot-Melt Adhesives, Method for the Production and the Use Thereof

(75) Inventors: Thorsten Brand, Marl (DE); Gabriele Brenner, Dulmen (DE); Giselher Franzmann, Witten (DE); Hans-Dieter Zagefka, Haltern am See (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Degussa AG, Duesseldorf (DE)

(21) Appl. No.: 10/589,980

(22) PCT Filed: Dec. 22, 2004
(86) PCT No.: PCT/EP04/53670

§ 371 Date: May 8, 2007

(30) Foreign Application Priority Data
Feb. 20, 2004 (DE) 102004008692.3
Jun. 11, 2004 (DE) 102004028488.1

(51) Int. Cl. C08F 8/30

(52) U.S. Cl. 525/123

(57) ABSTRACT

A description is given of moisture-crosslinking hotmelt adhesives for the immediate further processing of the bonded substrates, the adhesives comprising reaction products of difunctional and/or polyfunctional (poly)isocyanates with hydroxyl polyesters formed from polyols and dicarboxylic acids, use being made as dicarboxylic acid of a linear aliphatic dicarboxylic acid having from 13 to 22 methylene groups.

The present invention relates to the preparation of polyesters from long-chain linear dicarboxylic acids having 13-22 methylene groups and from polyols of any kind. The invention also describes the preparation of reactive hotmelt adhesives with the polyesters of the invention and the use thereof for joining, sealing and coating.

The shear resistance of hotmelt adhesives at elevated temperature is improved using reactive adhesive systems which either are crosslinked by input of energy or cure by means of moisture to form an unmeltable adhesive.

Numerous applications require rapid setting of the reactive hotmelt adhesives following their application in order to allow immediate further processing. This constitutes a problem for existing moisture-curing hotmelt adhesives.

It is a problem, for instance, for moisture-curing hotmelt adhesives from the class of the isocyanate-functional polymers, in accordance for example with DE 24 01 320 A, EP 0 107 097 A and EP 0 125 009 A. The chain backbone therein is formed predominantly by polyesters of adipic acid, butane-1,4-diol and hexane-1,6-diol. A reduction in the setting time can be achieved by adding resins and thermoplastic polymers. For this purpose EP 0 232 055 A describes the combination of liquid isocyanate prepolymers with ethylene/vinyl acetate copolymers or methylstyrene resins, EP 0 107 097 A with thermoplastic polyurethanes or condensation resins, and EP 0 246 473 A with acrylate oligomers. In these cases the thermoplastic fractions result in a reduction in the thermal shear resistance of such hotmelt adhesives after crosslinking by means of atmospheric moisture.

It is true that hotmelt adhesives according to EP 0 248 658 A, containing polyesters with more than 50% of aromatic rather than aliphatic dicarboxylic acid, have an improved setting rate. However, products of this kind possess the drawback of an excessive melt viscosity, which entails problems for the preparation of the prepolymers and for the processing of the hotmelt adhesives. In the preferred embodiment the free isocyanate groups are provided with a blocking agent, caprolactone for example, in order to improve the stability of the hotmelt adhesive in storage. For deblocking, however, substantially higher application temperatures are required by comparison with non-blocked polyisocyanates, which is to the detriment of the initial strengths of these hotmelt adhesives.

EP 0 340 906 describes quick-setting polyurethane adhesives which are composed of a mixture of at least two amorphous prepolymers characterized by different glass transition temperatures. The first polyurethane prepolymer has a glass transition temperature above room temperature and the second polyurethane prepolymer has a glass transition temperature below room temperature. The prepolymer with the higher glass transition temperature is preferably composed of a polyesterdiol and a polyisocyanate. The polyesterdiol may be a copolymer of aromatic acids (such as isophthalic or terephthalic acid) and/or aliphatic acids (such as adipic acid, azelaic acid or sebacic acid) and low molecular mass diols (such as ethylene glycol, butanediol, hexanediol). The prepolymer having the lower glass transition temperature is composed of a linear polyester or one with a low degree of branching, a polyether or another OH-terminated polymer, and polyisocyanate. Special polyesters such as polycaprolactones or polycarbonates can also be used. Crystalline polyesters formed from relatively long-chain dicarboxylic acids are not mentioned. The viscosity of the polyurethane hotmelt adhesives at 130° C. is situated in a range from at least 30 to 90 Pa·s.

WO 99/28363 describes a solvent-free moisture-curing polyurethane adhesive which is solid at room temperature, composed of a reaction product of a polyisocyanate and a low molecular mass polymer formed from ethylenically unsaturated monomers, the polymer carrying active hydrogen atoms, and also of at least one polyurethane prepolymer containing free isocyanate groups, prepared from at least one polyol and a polyisocyanate. The polyol may be a polyetherdiol, polyethertriol, polyesterpolyol, aromatic polyol or mixtures thereof.

By the polyesterdiol is meant a polyester having more than one OH group, preferably two terminal OH groups. The polyester is prepared either from aliphatic hydroxycarboxylic acids or from aliphatic and/or aromatic dicarboxylic acids having 6 to 12 carbon atoms and diols having 4 to 8 carbon atoms, by the known methods. The important copolyesters are those formed from
1. adipic acid, isophthalic acid and butanediol,
2. adipic acid, isophthalic acid and hexanediol,
3. adipic acid, isophthalic acid, phthalic acid, ethylene glycol, neopentyl glycol and 3-hydroxy-2,2-dimethylpropyl 3-hydroxy-2,2-dimethylpropanoate, and
4. adipic acid, phthalic acid, neopentyl glycol and ethylene glycol.

The polyesterpolyol is preferably amorphous but may also have a low level of crystallinity. Preference is given to using a mixture of an amorphous with a partially crystalline polyester. The crystallinity in this case must develop only to such a low extent that the finished adhesive is not opaque. The melting point of the partially crystalline polyester is in the range from 40 to 70° C., preferably in the range from 45 to 65° C. A preferred partially crystalline polyesterglycol used is butanediol adipate with a molecular weight of 3500 and a melting point of 50° C.

U.S. Pat. No. 6,221,978 describes a moisture-curable polyurethane adhesive composed of an epoxy resin and a polyurethane prepolymer. The polyurethane prepolymer is a reaction product of a polyol and a polyisocyanate. The polyol is a reaction product of aromatic dibasic acids, optionally comonomer dibasic acids and diols. Comonomer acids specified are dodecanedioic acid, succinic acid, glutaric acid, adipic acid, azelaic acid, sebacic acid, octadecanedicarboxylic acid, 1,4-cyclohexanedicarboxylic acid, dimer fatty acids and fumaric acid. In one particular embodiment the aromatic dibasic acid is isophthalic acid and the comonomer acid is adipic acid. It is of decisive importance that the aromatic dibasic acid is free from phthalic acid.

In one embodiment the adhesive further comprises crystalline polyesterpolyols. The crystalline polyesterpolyol is composed of a reaction product of an aliphatic diol having 2 to 10 methylene groups and an aliphatic dibasic acid having 2 to 10 methylene groups. In one particular embodiment the crystalline polyesterpolyol is composed of hexanediol and dodecanedioic acid.

The adhesive is used for bonding substrates that are difficult to bond and have a low surface energy. Rapid setting behavior on the part of the hotmelt adhesives described is not shown.

DE 38 27 224 A describes moisture-curing isocyanate-functional hotmelt adhesives with a particularly high setting rate. Essential to that invention is the use of polyesters whose backbone is preferably purely aliphatic and which contain at least 12 up to a maximum of 26 methylene groups in the repeating unit formed from diol and dicarboxylic acids, use being made of dicarboxylic acids containing 8-12 methylene groups. Particular preference is given to dicarboxylic acids with 10 methylene groups. Optionally up to 80 mol % of the aliphatic dicarboxylic acids may have been replaced by aromatic dicarboxylic acids.

In order to achieve a high setting rate it is necessary for the fraction of the polyesters essential to the invention to be at least 50% by weight, preferably more than 75% by weight, in the mixture.

Although that invention does represent a technical improvement, a further increase in the setting rate is nevertheless desirable, for more effective processing.

The object was therefore to develop moisture-crosslinking hotmelt adhesives which ensure a further-increased setting rate. This object has been achieved by provision of a hotmelt adhesive in accordance with the claims. Short setting times of reactive hotmelt adhesives which in the present case are solvent-free then make it possible to achieve higher cycle rates when such adhesives are processed in line production.

The invention provides hotmelt adhesives, and a process for preparing them, comprising reaction products of difunctional and/or polyfunctional (poly)isocyanates with hydroxyl polyesters based on linear aliphatic dicarboxylic acids having 13-22 methylene groups and polyols of any kind in an OH:NCO ratio of from 1:1.2 to 1:3.0, preferably from 1:1.5 to 1:2.5. The hydroxyl polyesters of the invention possess more than one OH group and with very particular preference are difunctional. Hydroxyl polyesters for the purposes of the invention have OH numbers of 5-150, preferably of 10-50, and acid numbers of below 10, preferably below 5 and more preferably below 2. The number-average molecular weight of the polyesters of the invention is 700-22 000 g/mol, preferably 2000-10 000 g/mol.

Surprisingly it has been found that with hydroxyl polyesters which on the acid side contain linear aliphatic dicarboxylic acids having 13-22 methylene groups it is possible to reduce the setting time and to increase the initial strength.

Particular embodiments use octadecanedioic acid and/or hexadecanedioic acid.

The melting point of the hydroxyl polyesters of the invention is situated in the range 30° C.-125° C., preferably 65° C.-115° C. and very preferably in a range of 70° C.-110° C.

Some of the hydroxyl polyesters based on long-chain dicarboxylic acids having 13-22 methylene groups may have been replaced by aliphatic and/or cycloaliphatic polycarboxylic, preferably dicarboxylic, acids having shorter carbon chains. Also suitable for replacing the long-chain dicarboxylic acids of the invention are dimer fatty acids. On the acid side there are 5-100 mol % of the long-chain dicarboxylic acids of the invention, preferably 20-100 mol % and more preferably 50-100 mol %.

Examples of aliphatic polycarboxylic acids having shorter chains are succinic acid, glutaric acid, adipic acid, azelaic acid, sebacic acid and dodecanedioic acid. Examples of cycloaliphatic dicarboxylic acids are the isomers of cyclohexanedicarboxylic acid. If desired, instead of the free acids, it is also possible to use their esterifiable derivatives, such as corresponding lower alkyl esters or cyclic anhydrides, for example.

In further embodiments of the hydroxyl polyesters of the invention the long-chain dicarboxylic acids having 13-22 methylene groups may include, in addition to the short-chain aliphatic and/or cycloaliphatic polycarboxylic acids and/or dimer fatty acids, or instead of them, aromatic polycarboxylic acids, preferably dicarboxylic acids, the polyesters on the acid side containing 5-100 mol % of the long-chain dicarboxylic acids of the invention, preferably 20-100 mol % and very preferably 50-100 mol %.

Examples of aromatic polycarboxylic acids are terephthalic acid, isophthalic acid, phthalic acid, naphthalenedicarboxylic acid, trimellitic acid and pyromellitic acid. Instead of the free polycarboxylic acids it is also possible to use their esterifiable derivatives, such as corresponding lower alkyl esters or cyclic anhydrides, for example.

Where the hydroxyl polyesters of the invention contain units originating from aromatic polycarboxylic acids, their melting point is situated in the range of 30° C.-140° C., preferably 65° C.-135° C. and very preferably in a range of 70° C.-130° C.

The nature of the polyols used for the hydroxyl polyesters of the invention is arbitrary per se. Thus aliphatic and/or cycloaliphatic and/or aromatic polyols may be present. By polyols are meant compounds which carry preferably more than one and more preferably two hydroxyl groups; deviating from the general definition it is also possible, in special embodiments, for monohydroxy compounds to be included in this term.

Examples of polyols are ethylene glycol, propane-1,2-diol, propane-1,3-diol, butane-1,4-diol, pentane-1,5-diol, hexane-1,6-diol, nonane-1,9-diol, dodecane-1,12-diol, neopentyl glycol, butylethylpropane-1,3-diol, methylpropanediol, methylpentanediols, cyclohexanedimethanols, trimethylolpropane, pentaerythritol and mixtures thereof.

By aromatic polyols are meant reaction products of aromatic polyhydroxy compounds, such as hydroquinone, bisphenol A, bisphenol F, dihydroxynaphthalene, etc., with epoxides, such as ethylene oxide or propylene oxide, for example. As polyols it is also possible for etherdiols to be present, i.e., oligomers or polymers based, for example, on ethylene glycol, propylene glycol or butane-1,4-diol. Particular preference is given to linear aliphatic glycols.

Besides polyols and polycarboxylic acids it is also possible to use lactones for synthesizing the hydroxyl polyesters.

The hydroxyl polyesters of the invention containing aliphatic dicarboxylic acids having 13-22 methylene groups are prepared by means of established techniques for condensation reactions. Use is made for this purpose of polyols of any kind and the polycarboxylic acid(s) of the invention or, if desired, this acid or these acids in a mixture with other (cyclo)aliphatic and/or aromatic polycarboxylic acids and/or their (trans)esterifiable derivatives, the equivalent ratio of hydroxyl groups to carboxyl groups being 1.02-1.5, preferably 1.05-1.3. The (poly)condensation takes place at temperatures of 150° C.-270° C. within 3-30 h, and after the majority of the theoretically calculated amount of water has been removed it is possible to operate in vacuo. As an option it is also possible to operate with the addition of catalysts for accelerating the (poly)condensation reaction and/or azeotrope formers for separating off the water of reaction. Typical catalysts are organotitanium or organotin compounds, such as tetrabutyl titanate or dibutyltin oxide, for example. The catalysts can be charged optionally at the beginning of the reaction, together with the other starting materials, or not until later, during the reaction. Azeotrope formers which may be used include, for example, toluene or various SolventNaphta® grades. Optionally the hydroxyl polyesters can be equipped with or without running assistants or additives such as antioxidants, for example.

The polyisocyanates may be difunctional and/or polyfunctional, aromatic, aliphatic and/or cycloaliphatic isocyanates. Aromatic polyisocyanates are particularly preferred. Examples of polyisocyanates are 4,4′-diphenylmethane diisocyanate, 2,4′-diphenylmethane diisocyanate, toluene diisocyanate isomers, isophorone diisocyanate, hexamethylene diisocyanate, 4,4′-dicyclohexylmethane diisocyanate and mixtures thereof.

In the hotmelt adhesives the fraction of the hydroxyl polyesters of the invention is 1-99% by weight, preferably 1-49% by weight and more preferably 1-35% by weight.

In preferred embodiments the hotmelt adhesives include not only the hydroxyl polyesters of the invention but also other polyols, this definition including polyesterpolyols, polyetherpolyols and arbitrary hydroxyl-functional components.

The admixed polyesterpolyols may be liquid and/or solid, amorphous and/or (partially) crystalline polyesters of arbitrary structure with molecular weights Mn of between 1000 g/mol and 30 000 g/mol, preferably between 2000 g/mol and 10 000 g/mol (calculated from the hydroxyl number), preference being given to the use of linear polyesterpolyols. The admixed polyetherpolyols are polyetherdiols and polyethertriols. Examples of such are homopolymers and copolymers of ethylene glycol, propylene glycol and butane-1,4-diol. The molecular weight Mn of the admixed polyetherpolyols ought to be situated within a range from 200 g/mol to 10 000 g/mol, preferably between 400 g/mol and 6000 g/mol.

Examples of arbitrary hydroxy-functional components are functionalized (H-acidic), thermoplastic polyurethanes (TPU) and/or polyacrylates and/or ethylene-vinyl acetate copolymers (EVA).

The hotmelt adhesives of the invention may contain up to 50% by weight of further additions. These additions may be the following: non-functionalized polymers, e.g., thermoplastic polyurethanes (TPU) and/or polyacrylates and/or ethylene-vinyl acetate copolymers (EVA); pigments and/or fillers, e.g., talc., silicon dioxide, titanium dioxide, barium sulfate, calcium carbonate, carbon black or colored pigments; tackifiers, such as rosins, hydrocarbon resins, phenolic resins; and also aging inhibitors and auxiliaries.

As is evident from the following inventive examples and corresponding comparative examples in accordance with the prior art, the use of the polyesters of the invention in hotmelt adhesives brings about a drastic reduction in the setting times, demonstrated using the test method described below.

### EXAMPLES

The present invention is described below with reference to inventive and comparative examples. The invention is not, however, restricted exclusively to these examples.

Preparation of the Inventive Hydroxyl Polyesters

### Example a

Octadecane-1,18-dioic acid (314 g, 1.0 mol) and hexane-1,6-diol (132 g, 1.1 mol) are melted in a stream of nitrogen in a 1 l flask with distillation attachment. When a temperature of 160° C. is reached water begins to distill off. Over the course of one hour the temperature is increased successively to 240° C. After a further hour at this temperature the elimination of water becomes slower. 50 mg of titanium tetrabutoxide are stirred in and operation continues in vacuo, which in the course of the reaction is adapted so that distillate continues to be produced. When the desired hydroxyl and acid number range has been reached, the experiment is discontinued. The hydroxyl number, acid number and melting point were determined as specified for table 1 and amount to 30 mg KOH/g, 1 mg KOH/g and 82° C.

The syntheses of the hydroxyl polyesters in inventive examples b-j and in comparative examples Ca-Cc take place in a way which is comparable with example a, using the diols and dicarboxylic acids indicated in table 1. In the case of example k a transesterification step of dimethyl terephthalate with a diol is inserted as an initial step, in accordance with established technique, and then operation continues as per example a.

TABLE 1
Composition of the base polyesters (in mol %) and their properties

| | Polyester composition | | | | | | | | | | | |
|---|---|---|---|---|---|---|---|---|---|---|---|---|
| | Acid component | | | | | Alcohol component | | | | Polyester properties | | |
| | DMT | AD | DDA | HDDA | ODDA | EG | BD | HD | NPG | OHN | AN | m.p. |
| Inventive | | | | | | | | | | | | |
| Example | | | | | | | | | | | | |
| A | | | | | 100 | | | 100 | | 30 | 1 | 82 |
| B | | | | | 100 | 100 | | | | 28 | 0.5 | 95 |
| c | | | | | 100 | | 100 | | | 28 | 3 | 84 |
| d | | 20 | | | 80 | | | 100 | | 29 | 2 | 78 |
| e | | | | | 100 | 10 | | 90 | | 28 | 1 | 81 |
| f | | | | | 100 | 20 | | 80 | | 30 | 0.5 | 80 |
| g | | | | | 100 | | | 30 | 70 | 31 | 1 | 34/49 |
| h | | 40 | | | 60 | | | 100 | | 34 | 2 | 71 |
| i | | | | 100 | | | | 100 | | 30 | 1 | 80 |
| j | | | | 100 | | 100 | | | | 32 | 1.5 | 92 |
| k | 40 | | | | 60 | | | 100 | | 31 | 1 | 65/72 |
| Comparative | | | | | | | | | | | | |
| examples | | | | | | | | | | | | |
| Ca | | | 100 | | | | | 100 | | 29 | 1 | 70 |
| Cb | | | 100 | | | 100 | | | | 29 | 1 | 85 |
| Cc | | | 100 | | | | | 30 | 70 | 30 | 0.5 | 15/23 |

DMT = dimethyl terephthalate
AD = adipic acid
DDA = dodecanedioic acid
HDDA = hexadecanedioic acid
ODDA = octadecanedioic acid
EG = ethylene glycol
BD = butane-1,4-diol
HD = hexane-1,6-diol
NPG = neopentyl glycol
OHN = hydroxyl number, reported in mg KOH/g, measured to DIN 53240-2
AN = acid number, reported in mg KOH/g, measured to DIN EN ISO 2114
m.p. = melting point, reported in ° C., DSC method, 2nd heating. Where two or more figures are reported there is a corresponding number of melting points.

Preparation and Characterization of the Moisture-Curing Hotmelt Adhesives

The moisture-curing hotmelt adhesives (RHMs) described in the examples below were characterized on the basis of their melt viscosity at 130° C. (Brookfield Thermosel, spindle 27), their softening point (ring & ball) to DIN ISO 46 and their setting time.

Setting Time

The setting time is the time required for two beechwood substrates bonded in the shape of a T (120 mm long, 20 mm wide, 5 mm thick) to attain a strength such that they can no longer be separated by loading them with a weight of 2 kg. The bonded area is 400 mm².

To produce the bond the adhesive, at a temperature of 130° C., is applied thinly to the area of the first substrate that is to be bonded, using a preheated metal spatula, and is immediately bonded with the opposing substrate in the form of a T. The long leg of the T is then loaded with a 2 kg weight as a function of time.

For the times between bonding and loading, the intervals amount to 5 seconds for a setting time of less than two minutes and 30 seconds for a setting time of more than two but less than ten minutes.

The setting time reported is the time of suspension of the weight whose load the bond has withstood for at least half an hour. The result is reported in seconds (s).

### Example RHM 1

In a 500 ml flask with ground-glass joints 300 g of the hydroxyl polyester g are melted and dried at 130° C. in vacuo. Thereafter 4,4′-diphenylmethanediisocyanate (MDI) is added in a molar OH/NCO ratio of 1/2.2 and the mixture is rapidly homogenized. For complete reaction of the reactants the mixture is stirred at 130° C. under an inert gas atmosphere for 45 minutes. Subsequently the moisture-curing hotmelt adhesive is discharged. The resulting hotmelt adhesive produces a melt viscosity (130° C.) of 5 Pa·s. The setting time is 5 seconds and the softening point (ring and ball) is 53° C.

Comparative Example RHM 2

The procedure is as for example RHM 1, replacing hydroxyl polyester g by hydroxyl polyester Cc. The resulting hotmelt adhesive possesses a melt viscosity (130° C.) of 6 Pa·s. The setting time is greater than 1800 seconds and the softening point (ring and ball) is 31° C.

The comparison of the two preceding examples shows the drastic reduction in setting time associated with use of the inventive polyesters.

### Example RHM 3

In a 500 ml flask with ground-glass joints 45.5 parts by weight of DYNACOLL 7130, 45.5 parts by weight of DYNACOLL 7230 and 9 parts by weight of the hydroxyl polyester a are melted and dried at 130° C. in vacuo. Thereafter 4,4′-diphenylmethanediisocyanate (MDI) is added in a molar OH/NCO ratio of 1/2.2 and the mixture is rapidly homogenized. For complete reaction of the reactants the mixture is stirred at 130° C. under an inert gas atmosphere for 45 minutes. Subsequently the moisture-curing hotmelt adhesive is discharged. The resulting hotmelt adhesive produces a melt viscosity (130° C.) of 18 Pa·s. The setting time is 50 seconds and the softening point (ring and ball) is 67° C.

### Comparative Example RHM 4

The procedure is as for example RHM 1, replacing hydroxyl polyester a by hydroxyl polyester Ca. The resulting hotmelt adhesive possesses a melt viscosity (130° C.) of 14 Pa·s. The setting time is >1800 seconds and the softening point (ring and ball) is 66° C.

The comparison of the two preceding examples shows the drastic reduction in setting time associated with use of the inventive polyesters.

RHMs 5-23

The procedure is as for example RHM 3, in accordance with the compositions indicated in table 2.

TABLE 2
Properties of moisture-curing hotmelt adhesives based on
mixtures of polyols and 4,4′-MDI (OH:NCO ratio 1:2.2)

| | RHM | | | | | | | | | |
|---|---|---|---|---|---|---|---|---|---|---|
| | 5 | 6 | 7 | 8 | 9 | 10 | 11 | 12 | 13 | 14 |
| Composition | | | | | | | | | | |
| DYNACOLL 7130 | 41.5 | 41.5 | 38.5 | 38.5 | 41.5 | 41.5 | 41.5 | 41.5 | 41.5 | 41.5 |
| DYNACOLL 7230 | 41.5 | 41.5 | 38.5 | 38.5 | 41.5 | 41.5 | 41.5 | 41.5 | 41.5 | 41.5 |
| DYNACOLL 7250 | | | | | | | | | | |
| PPG 1000 | | | | | | | | | | |
| Hydroxyl polyester a | 17 | | 23 | | | | | | | |
| Hydroxyl polyester b | | | | | 17 | | | | | |
| Hydroxyl polyester c | | | | | | | 17 | | | |
| Hydroxyl polyester d | | | | | | | | 17 | | |
| Hydroxyl polyester e | | | | | | | | | 17 | |
| Hydroxyl polyester f | | | | | | | | | | 17 |
| Hydroxyl polyester g | | | | | | | | | | |
| Hydroxyl polyester h | | | | | | | | | | |
| Hydroxyl polyester i | | | | | | | | | | |
| Hydroxyl polyester j | | | | | | | | | | |
| Hydroxyl polyester k | | | | | | | | | | |
| Hydroxyl polyester Ca | | 17 | | 23 | | | | | | |
| Hydroxyl polyester Cb | | | | | | 17 | | | | |
| Hydroxyl polyester Cc | | | | | | | | | | |
| RHM properties | | | | | | | | | | |
| Viscosities | 23 | 16 | 29 | 17 | 19 | 10 | 22 | 21 | 22 | 22 |
| (130° C./Pa · s) | | | | | | | | | | |
| m.p.(R&B) (° C.) | 67 | 67 | 70 | 67 | 64 | 82 | 67 | 66 | 67 | 67 |
| Setting time (s) | 20 | >1800 | 5 | >600 | 5 | 1800 | 5 | 20 | 5 | 5 |

| | RHM | | | | | | | | |
|---|---|---|---|---|---|---|---|---|---|
| | 15 | 16 | 17 | 18 | 19 | 20 | 21 | 22 | 23 |
| Composition | | | | | | | | | |
| DYNACOLL 7130 | 38.5 | 38.5 | 58 | 58 | 58 | 41.5 | 41.5 | 41.5 | 41.5 |
| DYNACOLL 7230 | 38.5 | 38.5 | | | | 41.5 | 41.5 | 41.5 | 41.5 |
| DYNACOLL 7250 | | | 25 | 25 | | | | | |
| PPG 1000 | | | | | 25 | | | | |
| Hydroxyl polyester a | | | | | | | | | |
| Hydroxyl polyester b | | | 17 | | 17 | | | | |
| Hydroxyl polyester c | | | | | | | | | |
| Hydroxyl polyester d | | | | | | | | | |
| Hydroxyl polyester e | | | | | | | | | |
| Hydroxyl polyester f | | | | | | | | | |
| Hydroxyl polyester g | 23 | | | | | | | | |
| Hydroxyl polyester h | | | | | | 17 | | | |
| Hydroxyl polyester i | | | | | | | 17 | | |
| Hydroxyl polyester j | | | | | | | | 17 | |
| Hydroxyl polyester k | | | | | | | | | 17 |
| Hydroxyl polyester Ca | | | | | | | | | |
| Hydroxyl polyester Cb | | | | 17 | | | | | |
| Hydroxyl polyester Cc | | 23 | | | | | | | |
| RHM properties | | | | | | | | | |
| Viscosities | 20 | 21 | 18 | 15 | 12 | 17 | 19 | 18 | 21 |
| (130° C./Pa · s) | | | | | | | | | |
| m.p.(R&B) (° C.) | 67 | 62 | 69 | 80 | 75 | 67 | 66 | 65 | 66 |
| Setting time (s) | 40 | >1800 | 40 | >1800 | 5 | 330 | 20 | 15 | 350 |

RHMs 6, 8, 10, 16 and 18 are comparative examples

4,4′-MDI=4,4′-diphenylmethane diisocyanate, e.g., Desmodur 44 MC (Bayer), Suprasec 1306 (Huntsman), isonate M124 (Dow)

DYNACOLL 7130 is an amorphous polyester formed from C₂, C₅ and C₁₀ diols, adipic acid, terephthalic acid and isophthalic acid, from Degussa, with a glass transition temperature Tg=30° C. and a hydroxyl number of 35 mg KOH/g.

DYNACOLL 7230 is a liquid polyeseter formed from C₂, C₅ and C₆ diols, adipic acid, terephthalic acid and isophthalic acid, from Degussa, with a Tg of −30° C. and a hydroxyl number of 30 mg KOH/g.

DYNACOLL 7250 is a liquid polyester formed from C₂, C₅ and C₆ diols and adipic acid, from Degussa, with a Tg of −50° C. and a hydroxyl number of 20 mg KOH/g.

PPG 1000 is a polypropylene glycol having a molecular weight of approximately 1000 g/mol

### Example RHM 24

A moisture-curing hotmelt adhesive is prepared from the following components in the same way as for RHM 3: (amounts in parts by weight)

44.2 polypropylene glycol, molecular weight 2000, OH number 56

17.7 hydroxyl polyester a

24.5 Elvacite 2901 (OH-containing polyacrylate from Lucite, OH number 6 mg KOH/g)

10.2 Mondur ML (2,4/4,4′-MDI from Bayer)

The viscosity at 130° C. is 26 Pas. The softening point is 89° C. The setting time is 10 seconds.

### Comparative Example RHM 25

The procedure is as for RHM 24. (amounts in parts by weight)

44.2 polypropylene glycol, molecular weight 2000, OH number 56

17.7 hexanediol adipate, molecular weight about 3500

24.5 Elvacite 2901 (OH-containing polyacrylate from Lucite, OH number 6 mg KOH/g)

10.2 Mondur ML (2,4/4,4′-MDI from Bayer)

The viscosity at 130° C. is 16 Pas. The softening point is 64° C. The setting time is 200 seconds.

The examples show that hydroxyl polyesters based on long-chain dicarboxylic acids having 13-22 methylene groups drastically shorten the setting time of hotmelt adhesives, with less than 50% by weight of the inventive polyesters in the mixture being enough to achieve the effect.

The hotmelt adhesives of the invention are suitable preferentially for those applications in which the substrates to be bonded to one another are to be sent on for immediate further processing without additional mechanical or other fixing. This suitability derives from the rapid development of a sufficient initial strength as the bond cools, even before curing by moisture crosslinking of the isocyanate groups. Examples of such applications are found in the wood-processing industry, automobile industry, construction industry, footwear industry and textile industry.

1. A moisture-crosslinking hotmelt adhesive for the immediate further processing of bonded substrates, comprising reaction products of difunctional and/or polyfunctional (poly)isocyanates with hydroxyl polyesters formed from polyols and dicarboxylic acids or derivatives thereof suitable for condensation reactions, wherein at least one linear aliphatic dicarboxylic acid having from 13 to 22 methylene groups is used as dicarboxylic acid.

2. A moisture-crosslinking hotmelt adhesive as claimed in claim 1, containing 1-99% by weight of the polyesters.

3. A moisture-crosslinking hotmelt adhesive as claimed in claim 1, containing 1-49% by weight of the polyesters.

4. A moisture-crosslinking hotmelt adhesive as claimed in claim 1, containing 1-35% by weight of the polyesters.

5. A moisture-crosslinking hotmelt adhesive as claimed in claim 1, wherein octadecanedioic acid is used as dicarboxylic acid.

6. A moisture-crosslinking hotmelt adhesive as claimed in claim 1, wherein hexadecanedioic acid is used as dicarboxylic acid.

7. A moisture-crosslinking hotmelt adhesive as claimed in claim 1, wherein the hydroxyl polyesters possess a melting point of 30° C.-125° C.

8. A moisture-crosslinking hotmelt adhesive as claimed in claim 1, wherein the hydroxyl polyesters possess a melting point of 65° C.-115° C.

9. A moisture-crosslinking hotmelt adhesive as claimed in claim 1, wherein the hydroxyl polyesters possess a melting point of 70° C.-110° C.

10. A moisture-crosslinking hotmelt adhesive as claimed in claim 1, wherein up to 95 mol % of the linear aliphatic dicarboxylic acid having from 13 to 22 methylene groups has been replaced by dicarboxylic acids having shorter carbon chains.

11. A moisture-crosslinking hotmelt adhesive as claimed in claim 1, wherein up to 80 mol % of the linear aliphatic dicarboxylic acid having from 13 to 22 methylene groups has been replaced by dicarboxylic acids having shorter carbon chains.

12. A moisture-crosslinking hotmelt adhesive as claimed in claim 1, wherein up to 50 mol % of the linear aliphatic dicarboxylic acid having from 13 to 22 methylene groups has been replaced by dicarboxylic acids having shorter carbon chains.

13. A moisture-crosslinking hotmelt adhesive as claimed in claim 1, wherein up to 95 mol % of the linear aliphatic dicarboxylic acid having from 13 to 22 methylene groups has been replaced by aromatic dicarboxylic acids.

14. A moisture-crosslinking hotmelt adhesive as claimed in claim 1, wherein up to 80 mol % of the linear aliphatic dicarboxylic acid having from 13 to 22 methylene groups has been replaced by aromatic dicarboxylic acids.

15. A moisture-crosslinking hotmelt adhesive as claimed in claim 1, wherein up to 50 mol % of the linear aliphatic dicarboxylic acid having from 13 to 22 methylene groups has been replaced by aromatic dicarboxylic acids.

16. A moisture-crosslinking hotmelt adhesive as claimed in claim 1, wherein the hydroxyl polyesters possess a melting point of 30° C.-140° C. if they contain aromatic dicarboxylic acids as comonomers.

17. A process for producing a moisture-crosslinking hotmelt adhesive for the immediate further processing of bonded substrates, comprising forming reaction products of difunctional and/or polyfunctional (poly)isocyanates with hydroxyl polyesters formed from polyols and dicarboxylic acids or derivatives thereof suitable for condensation reactions, wherein at least one linear aliphatic dicarboxylic acid having from 13 to 22 methylene groups is used as dicarboxylic acid.

18. A process for producing a moisture-crosslinking hotmelt adhesive as claimed in claim 17, wherein octadecanedioic acid is used as dicarboxylic acid.

19. A process for producing a moisture-crosslinking hotmelt adhesive as claimed in claim 17, wherein hexadecanedioic acid is used as dicarboxylic acid.

20. A process for producing a moisture-crosslinking hotmelt adhesive as claimed in claim 17, wherein the hydroxyl polyesters possess a melting point of 30° C.-125° C.

21. A process for producing a moisture-crosslinking hotmelt adhesive as claimed in claim 17, wherein the hydroxyl polyesters possess a melting point of 65° C.-115° C.

22. A process for producing a moisture-crosslinking hotmelt adhesive as claimed in claim 17, wherein the hydroxyl polyesters possess a melting point of 70° C.-110° C.

23. A process for producing a moisture-crosslinking hotmelt adhesive as claimed in claim 17, wherein up to 95 mol % of the linear aliphatic dicarboxylic acid having from 13 to 22 methylene groups has been replaced by dicarboxylic acids having shorter carbon chains.

24. A process for producing a moisture-crosslinking hotmelt adhesive as claimed in claim 17, wherein up to 80 mol % of the linear aliphatic dicarboxylic acid having from 13 to 22 methylene groups has been replaced by dicarboxylic acids having shorter carbon chains.

25. A process for producing a moisture-crosslinking hotmelt adhesive as claimed in claim 17, wherein up to 50 mol % of the linear aliphatic dicarboxylic acid having from 13 to 22 methylene groups has been replaced by dicarboxylic acids having shorter carbon chains.

26. A process for producing a moisture-crosslinking hotmelt adhesive as claimed in claim 17, wherein up to 95 mol % of the linear aliphatic dicarboxylic acid having from 13 to 22 methylene groups has been replaced by aromatic dicarboxylic acids.

27. A process for producing a moisture-crosslinking hotmelt adhesive as claimed in claim 17, wherein up to 80 mol % of the linear aliphatic dicarboxylic acid having from 13 to 22 methylene groups has been replaced by aromatic dicarboxylic acids.

28. A process for producing a moisture-crosslinking hotmelt adhesive as claimed in claim 17, wherein up to 50 mol % of the linear aliphatic dicarboxylic acid having from 13 to 22 methylene groups has been replaced by aromatic dicarboxylic acids.

29. A process for producing a moisture-crosslinking hotmelt adhesive as claimed in claim 17, wherein the hydroxyl polyesters possess a melting point of 30° C.-140° C. if they contain aromatic dicarboxylic acids as comonomers.

30. A process for bonding substrates to permit immediate further processing thereof, comprising applying to a substrate a moisture-crosslinking hotmelt adhesive as claimed in claim 1.
